(19) United States
(12) Patent Application Publication
(10) Pub. No.: US 2026/0200243 A1
(43) Pub. Date: Jul. 16, 2026

(54) INFERENCE APPARATUS, INFERENCE SYSTEM, AND TRAINED MODEL GENERATION APPARATUS

(71) Applicants: Ryoma TADA, Kanagawa (JP); Yuta HAYASHI, Tokyo (JP)

(72) Inventors: Ryoma TADA, Kanagawa (JP); Yuta HAYASHI, Tokyo (JP)

(73) Assignee: ETRIA CO., LTD., Yokohama (JP)

(21) Appl. No.: 19/357,508

(22) Filed: Oct. 14, 2025

(30) Foreign Application Priority Data
Jan. 16, 2025 (JP) 2025-006221

(51) Int. Cl. B41J 11/00; G06N 5/04

(52) U.S. Cl. CPC B41J 11/006; B41J 11/007; G06N 5/04

(57) ABSTRACT

An inference apparatus includes a sheet jam detector to detect occurrence of a jam of a sheet on a conveyance path in a case that the sheet is conveyed along the conveyance path by an operation of a sheet conveyor and circuitry to acquire information indicating a state of the sheet conveyor and a state of the sheet on the conveyance path in a case that the occurrence of the jam is detected, input information indicating at least one of the state of the sheet conveyor or the state of the sheet on the conveyance path to a learning model, the learning model being generated by performing machine learning to infer a cause of the jam of the sheet, and receive an inference result of the cause of the jam from the learning model.

### CROSS-REFERENCE TO RELATED APPLICATIONS

This patent application is based on and claims priority pursuant to 35 U.S.C. §119(a) to Japanese Patent Application No. 2025-006221, filed on Jan. 16, 2025, in the Japan Patent Office, the entire disclosure of which is hereby incorporated by reference herein.

### BACKGROUND

### Technical Field

The present disclosure relates to an inference apparatus, an inference system, and a trained model generation apparatus.

### Related Art

Image forming apparatuses often include a sheet conveyor for conveying a sheet to be printed. In such an image forming apparatus, a so-called jam (sheet jam) may occur in which the sheet fed into the sheet conveyor becomes stuck and interrupts the operation.

In such an image forming apparatus in the related art, in order to shorten downtime due to a sheet jam, an artificial intelligence (AI) function is used. The AI function recognizes a sign of the occurrence of a sheet jam based on information (e.g., a sheet size and environmental information) collected from the image forming apparatus. When the occurrence of a sheet jam is predicted, maintenance is performed in advance for preventing the occurrence of the sheet jam. As described above, such a technique has been proposed in which the occurrence of a sheet jam is prevented by performing maintenance when the occurrence of the sheet jam is predicted.

### SUMMARY

The present disclosure described herein provides an inference apparatus including a sheet jam detector to detect occurrence of a jam of a sheet on a conveyance path in a case that the sheet is conveyed along the conveyance path by an operation of a sheet conveyor and circuitry to acquire information indicating a state of the sheet conveyor and a state of the sheet on the conveyance path in a case that the occurrence of the jam is detected, input information indicating at least one of the state of the sheet conveyor or the state of the sheet on the conveyance path to a learning model, the learning model being generated by performing machine learning to infer a cause of the jam of the sheet, and receive an inference result of the cause of the jam from the learning model.

The present disclosure described herein provides an inference system including an apparatus including a sheet conveyor to convey a sheet along a conveyance path, apparatus circuitry, and a sheet jam detector to detect occurrence of a jam of the sheet on the conveyance path, and a server including system circuitry. The apparatus circuitry and the system circuitry operate in cooperation to acquire information indicating a state of the sheet conveyor and a state of the sheet on the conveyance path in a case that the occurrence of the jam is detected, input information indicating at least one of the state of the sheet conveyor or the state of the sheet on the conveyance path to a learning model, the learning model being generated by performing machine learning to infer a cause of the jam of the sheet, receive an inference result of the cause of the jam from the learning model, store, in a memory, a table associating the cause of the jam with a resolution method for resolving the cause, and display, on a display, information indicating the cause of the jam received as the inference result and the resolution method associated with the cause of the jam in the table.

The present disclosure described herein provides a trained model generation apparatus including circuitry to perform machine learning using, as training data, data associating information indicating a state of a sheet conveyor and a state of a sheet on a conveyance path in a case that a jam of the sheet occurs on the conveyance path along which the sheet is conveyed by an operation of the sheet conveyor with a cause of the jam, to generate a learning model.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming apparatus according to one aspect of the present disclosure;

FIG. 2 is a block diagram illustrating an image forming system according to a first embodiment;

FIG. 3 is a block diagram illustrating a hardware configuration of an image forming apparatus according to the first embodiment;

FIG. 4 is a block diagram illustrating a hardware configuration of an information processing apparatus applicable to a machine learning server according to the first embodiment;

FIG. 5 is a block diagram illustrating a software configuration of each apparatus included in an image forming system according to the first embodiment;

FIG. 6 is a diagram illustrating a table structure of a jam countermeasure table according to the first embodiment;

FIG. 7 is a diagram illustrating an example of a procedure for inferring the cause of a sheet jam in an image forming system according to the first embodiment;

FIG. 8 is a diagram illustrating another example of a procedure for inferring the cause of a sheet jam in an image forming system according to the first embodiment;

FIG. 9 is a diagram illustrating still another example of a procedure for inferring the cause of a sheet jam in an image forming system according to the first embodiment;

FIGS. 10A to 10C are diagrams each illustrating how the cause of a sheet jam is inferred based on a sheet size set in a print setting and a sheet size calculated based on a detection result of a conveyance sensor;

FIG. 11 is a diagram illustrating a screen displayed on a display by a display control unit according to the first embodiment;

FIG. 12 is a diagram illustrating the cause of a sheet jam determined based on sheet damage information;

FIG. 13 is a diagram illustrating the structure of a machine learning model generated by a machine learning server according to the first embodiment;

FIG. 14 is a conceptual diagram illustrating machine learning performed by a machine learning unit of a machine learning server according to the first embodiment;

FIG. 15 is a flowchart of the processing at the occurrence of a sheet jam in an image forming apparatus according to the first embodiment; and

FIG. 16 is a block diagram illustrating a software configuration of an image forming apparatus according to the first embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An inference apparatus, an inference system, and a trained model generation apparatus according to one aspect of the present disclosure are described in detail below with reference to the drawings.

### First Embodiment

An image forming apparatus according to one aspect of the present disclosure may be, for example, a full-color multifunction peripheral/product/printer (MFP) that forms a color image according to an electrophotographic system.

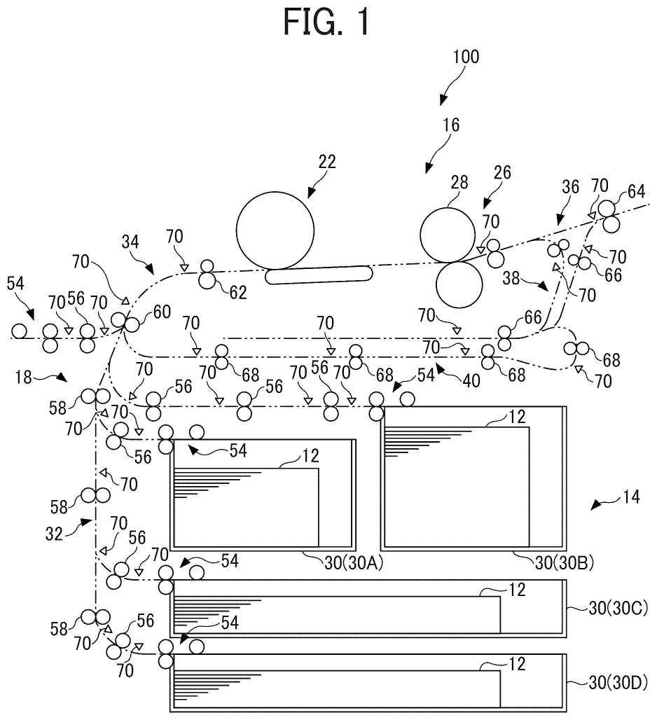

FIG. 1 is a schematic diagram illustrating an image forming apparatus 100 according to one aspect of the present disclosure. The image forming apparatus 100 illustrated in FIG. 1 includes a sheet feeder 14, an image forming device 16, and a sheet conveyor 18. In the sheet feeder 14, a sheet 12 used for image formation is loaded. The image forming device 16 forms an image on the sheet 12 using an electrophotographic process. The sheet conveyor 18 conveys the sheet 12.

The sheet feeder 14 includes multiple sheet feeding trays 30 (30A, 30B, 30C, and 30D), each of which stacks and stores a large number of sheets 12, and a manual sheet feeding tray. The sheet feeder 14 also includes multiple feed roller pairs 54 for feeding each sheet 12 from each of the multiple sheet feeding trays 30 or the manual sheet feeding tray. Each of the multiple feed roller pairs 54 may include a separation roller for separating the fed sheet 12 one by one.

The sheet conveyor 18 causes various types of roller pairs to perform operations so that the sheet 12 is conveyed along a conveyance path. For example, the sheet conveyor 18 includes multiple conveyance roller pairs 56 and 58 that convey the sheet 12 from the sheet feeder 14 to the image forming device 16 on a feeding conveyance path 32.

The sheet conveyor 18 further includes multiple conveyance roller pairs 60 and 62 that convey the sheet 12 that has been conveyed on the feeding conveyance path 32 along a registration conveyance path 34 on which the sheet 12 is conveyed to a transfer position.

The sheet 12 fed from a sheet feeding tray 30 is conveyed to the transfer position along the feeding conveyance path 32 and the registration conveyance path 34.

The image forming device (printer engine) 16 includes a transfer assembly 22 and a fixing assembly 26.

The transfer assembly 22 transfers a toner image formed on, for example, a photoconductor to the sheet 12 conveyed by the sheet conveyor 18.

The fixing assembly 26 fixes the toner image transferred to the sheet 12 by the transfer assembly 22 using a fixing (pressure) roller pair 28.

The sheet conveyor 18 is provided with an ejecting conveyance path 36 for conveying the sheet 12 fed by the fixing assembly 26 toward the outside of the image forming apparatus. The sheet 12 on which the image is formed passes along the ejecting conveyance path 36, and is then ejected to an ejection tray via an ejection roller pair 64 that ejects the sheet 12 to the outside of the image forming apparatus 100.

For the purpose of printing on both sides of the sheet, the sheet conveyor 18 is provided with conveyance roller pairs 66 and 68 that convey the sheet 12 fed from the fixing assembly 26 to conveyance paths 38 and 40 on which the sheet 12 is conveyed to the transfer position again.

On the other hand, the sheet conveyor 18 is provided, between the roller pirs disposed in each conveyance path, with multiple conveyance sensors 70 for detecting the passage of the sheet 12. The multiple conveyance sensors 70 enables detection of whether the sheet 12 is being conveyed at an appropriate timing.

A conveyance sensor 70 may be, for example, a reflective photosensor that optically detects the presence of the sheet 12. While detecting the sheet 12, the conveyance sensor 70 outputs a detection signal to a central processing unit (CPU) 1201 of the image forming apparatus 100, which will be described later.

The conveyance sensors 70 are disposed at predetermined intervals on the conveyance paths of the sheet conveyor 18. Accordingly, the CPU 1201 can recognize the position of the sheet 12 on the conveyance paths based on the detection signal transmitted from the conveyance sensors 70. When a sheet jam occurs on the conveyance paths, the CPU 1201 can recognize a position where the sheet jam occurs based on the detection signal transmitted from the conveyance sensor 70. Accordingly, each conveyance sensor 70 functions as a sheet jam detector that can detect a sheet jam of the sheet 12 on the conveyance paths.

The sheet conveyor 18 further includes a motor that rotates and drives multiple rollers to rotate and a clutch that connects the rollers and the motor. The devices such as the various rollers, the motor, and the clutch included in the sheet conveyor 18 may deteriorate or change in performance over time. The deterioration or change in performance over time may cause a sheet jam of the sheet 12. Similarly, the sheet conveyor 18 may also cause a sheet jam when the sheet information (e.g., a sheet size, a sheet thickness) set by a user is different from the characteristics of the sheet 12 actually detected.

As known in the art, when a sheet jam occurs during the processing of image formation, the processing is stopped and the image forming apparatus enters a sheet jam state. In this case, the user is required to remove the sheet jammed in the image forming apparatus. Thus, the image forming apparatus is restored to the normal state, and becomes ready for use in the processing such as the image formation. However, when the cause of the sheet jam is not resolved, a sheet jam occurs each time the image forming apparatus performs the processing of image formation and a state where the image forming apparatus is inoperable repeatedly occurs. As described above, unless the cause of the sheet jam is resolved, the downtime of the image forming apparatus is extended.

In view of the above, the image forming apparatus 100 according to the present embodiment infers the cause of a sheet jam when a sheet jam of the sheet 12 occurs. The downtime is shortened by the user taking a measure to resolve the cause of the sheet jam based on the result of the inference.

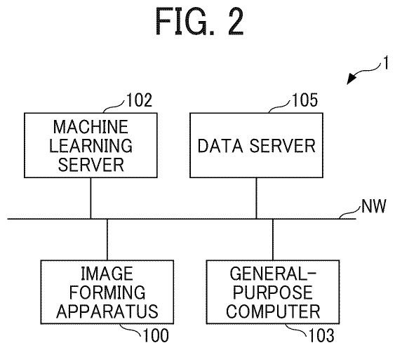

FIG. 2 is a block diagram illustrating an image forming system 1 according to the present embodiment. The image forming system 1 illustrated in FIG. 2 includes, for example, the image forming apparatus 100 such as a printer, a multifunction peripheral, or a facsimile machine, a machine learning server 102, a data server 105, and a general-purpose computer 103 that transmits print data to the image forming apparatus 100. These apparatuses illustrated in FIG. 2 are connected through a network NW such as a local area network (LAN) and can communicate with each other. The network NW may be wired or wireless. Further, the network NW may be a public communication line. For example, the machine learning server 102 and the data server 105 may be communicably connected to the image forming apparatus 100 via a public communication line.

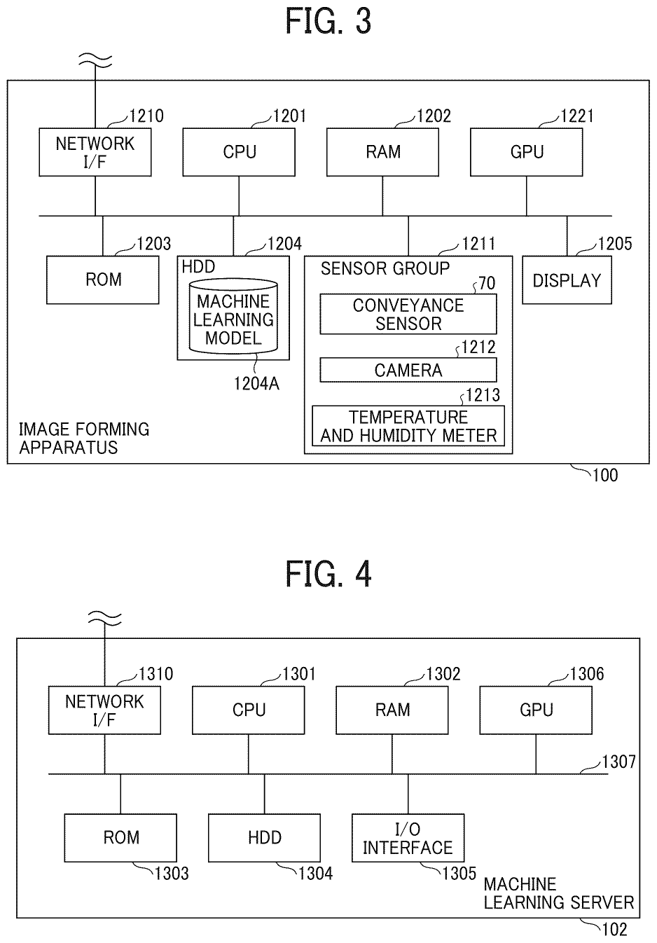

The image forming apparatus 100 has an artificial intelligence (AI) function and functions as an inference apparatus that can infer the cause of a sheet jam using the AI function. The image forming apparatus 100 is provided with a machine learning model 1204A (see FIG. 3) for implementing the AI function.

The data server 105 collects, for example, from the image forming apparatus 100, a detection result of a sensor group 1211 included in the image forming apparatus 100 and information indicating the current settings of the image forming apparatus 100 when the sheet jam occurs. The data server 105 provides the collected information to the machine learning server 102.

The machine learning server 102 generates training data based on the information provided by the data server 105, and generates the machine learning model 1204A for implementing the AI function using a part of or all of the generated training data.

FIG. 3 is a block diagram illustrating a hardware configuration of the image forming apparatus 100 according to the present embodiment. As illustrated in FIG. 3, the image forming apparatus 100 includes the CPU 1201, a random-access memory (RAM) 1202, a read-only memory (ROM) 1203, a hard disk drive (HDD) 1204, a network interface (I/F) 1210, a graphics processing unit (GPU) 1221, the sensor group 1211, and a display 1205.

The CPU 1201 is a controller that controls the overall operation of the image forming apparatus 100. The RAM 1202 is a system memory for the CPU 1201 to perform operations, and also serves as an image memory for temporarily storing, for example, image data. The ROM 1203 stores, for example, programs to be executed by the CPU 1201.

The HDD 1204 stores, for example, system software, image data, and values counted by software used for the image forming apparatus 100. The HDD 1204 also stores the machine learning model 1204A. The machine learning model 1204A will be described later. Instead of or in addition to the HDD, the image forming apparatus may include another type of a storage device such as a solid-state drive (SSD).

The network I/F 1210 is connected to the network NW and communicates with the general-purpose computer 103, the machine learning server 102, the data server 105, and other computer terminals on the network NW. The network I/F 1210 may also perform data communication with a facsimile machine externally connected. The network I/F 1210 has a wireless communication function for wirelessly connecting to an external communication terminal.

The sensor group 1211 is a group of sensors included in the image forming apparatus 100 for detecting the state of the sheet conveyor 18 of the image forming apparatus 100 and the state of the sheet 12 on the conveyance path. For example, the sensor group 1211 includes the conveyance sensor 70 as a sensor for detecting the state of the sheet conveyor 18 of the image forming apparatus 100. The sensor group 1211 also includes a camera 1212 disposed on the conveyance path as a sensor for detecting the state of the sheet 12 on the conveyance path. The sensor group 1211 further includes a temperature and humidity meter 1213 as a sensor for detecting the environment of the sheet conveyor 18.

The camera 1212 is disposed so as to capture an image of the sheet 12 being conveyed on the conveyance path. For example, when the occurrence of a sheet jam is detected, the camera 1212 captures an image of the sheet 12 on the conveyance path and transmits the information on the captured image to the CPU 1201. The camera 1212 captures an image of the sheet 12 on the conveyance path to function as a sheet state detection device that can obtain a damage state (a degree of damage) of the sheet 12 being conveyed on the conveyance path.

The temperature and humidity meter 1213 detects the temperature and humidity around the sheet conveyor 18 as information indicating the environment in which the sheet conveyor 18 is disposed, and transmits the detection result to the CPU 1201. In the present embodiment, the temperature and humidity meter 1213 is used as an example of an environment detection device that detects the environment around the image forming apparatus 100. However, the environment detection device is not limited to the temperature and humidity meter 1213, and may include, for example, an acceleration meter for detecting vibrations around the image forming apparatus 100.

The sensors included in the sensor group 1211 are not limited to the conveyance sensor 70, the camera 1212, and the temperature and humidity meter 1213, but may be other sensors.

The display 1205 is a display device such as a display that displays a display screen such as an operation screen or a setting screen.

The GPU 1221 is hardware that can perform mathematical calculations at high speed. The image forming apparatus 100 can process more data in parallel by causing the GPU 1221 to perform the processing. Accordingly, the image forming apparatus 100 can efficiently perform calculations by including the GPU 1221. The image forming apparatus 100 according to the present embodiment may use the GPU 1221 for the processing performed by an inference unit 1516 to be described later. Furthermore, the image forming apparatus 100 according to the present embodiment may be configured such that the processing of the inference unit 1516 is performed using only the CPU 1201 or the GPU 1221.

FIG. 4 is a block diagram illustrating a hardware configuration of an information processing apparatus applicable to the machine learning server 102 according to the present embodiment.

As illustrated in FIG. 4, the machine learning server 102 includes a CPU 1301, a RAM 1302, a ROM 1303, an HDD 1304, a network I/F 1310, an input/output (I/O) interface 1305, a GPU 1306, and a system bus 1307 that interconnects these components.

The CPU 1301 reads out programs such as an operating system (OS) and application software from the HDD 1304 and executes the programs to provide various functions. The RAM 1302 is a system memory used when the CPU 1301 executes the programs. The ROM 1303 stores programs for activating, for example, a basic input/output system (BIOS) and the OS, and setting files.

The HDD 1304 stores, for example, system software. Instead of or in addition to the HDD, the image forming apparatus may include another type of a storage device such as an SSD.

The network I/F 1310 is connected to the network NW and communicates with external devices such as the general-purpose computer 103, the data server 105, and the image forming apparatus 100.

The I/O interface 1305, which may be implemented by an interface circuit, is an interface for inputting or outputting information to or from an operation device that includes a liquid crystal display having, for example, a multi-touch sensor. The I/O interface 1305 outputs information on a screen according to a program so that the screen is displayed, based on the information on the screen, on the liquid crystal display of the operation device with, for example, a predetermined resolution and a predetermined number of colors. For example, a graphical user interface (GUI) screen is displayed on the liquid crystal display of the operation device. The GUI screen includes various windows or data used for operation. The I/O interface 1305 receives, from the operation device, information on the operation based on an input to the multi-touch sensor, and transfers the information on the operation to the CPU 1301. The machine learning server 102 may not be provided with an operation device.

The GPU 1306 is hardware that can perform mathematical calculations at high speed. The machine learning server 102 can process more data in parallel by causing the GPU 1306 to perform the processing. Accordingly, the image forming apparatus 100 can efficiently perform calculations by including the GPU 1306.

For example, in performing machine learning such as deep learning multiple times, the machine learning server 102 can effectively perform the processing using the GPU 1306.

In the present embodiment, when a machine learning unit 1532 (see FIG. 4), which will be described later, performs machine learning, the GPU 1306 is used in addition to the CPU 1301. Specifically, the CPU 1301 and the GPU 1306 operate in cooperation with each other to perform machine learning on a neural network using training data to generate a machine learning model. In the present embodiment, the machine learning is performed by the CPU 1301 and the GPU 1306 operating in cooperation with each other. However, the machine learning may be performed using only the CPU 1301 or the GPU 1306.

Each of the data server 105 and the general-purpose computer 103 can be implemented with the same hardware configuration as that of the machine learning server 102, and the descriptions thereof are omitted. The machine learning server 102 and the data server 105 may be implemented in the same computer. Alternatively, the image forming apparatus 100 may have the same functions as those of the machine learning server 102 and the data server 105.

Each of the machine learning server 102 and the data server 105 may be implemented by a single computer or multiple computers. Alternatively, each of the machine learning server 102 and the data server 105 may be implemented using a cloud computing technology.

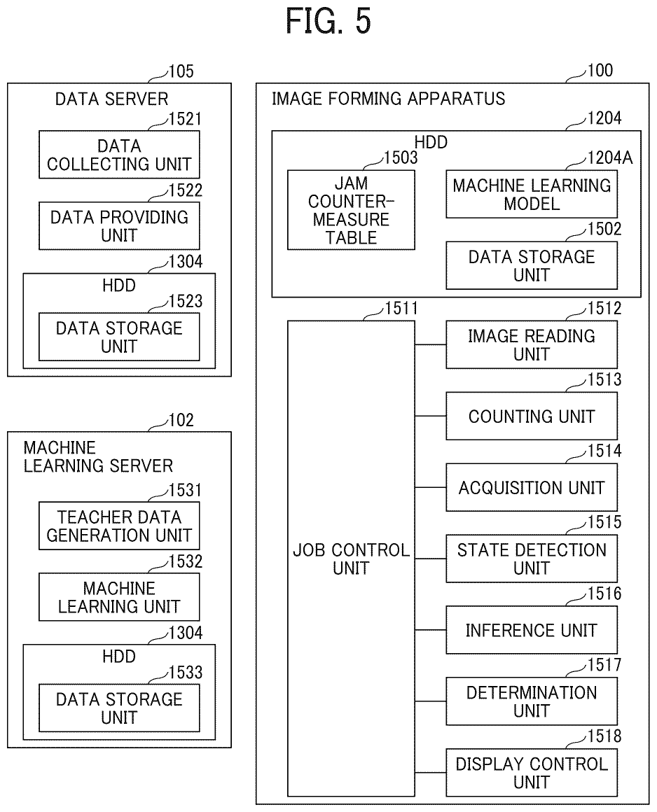

FIG. 5 is a block diagram illustrating a software configuration of each apparatus included in the image forming system 1 according to the present embodiment. In FIG. 5, software configurations implemented by using the hardware resources of the respective apparatuses illustrated in FIGS. 2 to 4 included in the image forming system 1 according to the present embodiment and programs are illustrated.

The image forming system 1 according to the present embodiment functions as an inference system that infers the cause of a sheet jam when the sheet jam occurs in the image forming apparatus 100. The image forming system 1 according to the present embodiment uses an AI function to infer the cause of the sheet jam. To utilize the AI function, a learning phase and an inference phase need to be performed. In the present embodiment, the machine learning server 102 performs the learning phase, and the image forming apparatus 100 performs the inference phase.

The programs for implementing each of the software configurations illustrated in FIG. 5 are stored in a storage device (e.g., an HDD) included in each apparatus. The CPU of each apparatus loads the stored programs onto the RAM and executes the programs.

For example, in the image forming apparatus 100, programs are stored in the HDD 1204. The CPU 1201 loads the stored programs onto the RAM 1202 and executes the programs. The stored programs may be executed by the GPU 1221 in addition to the CPU 1201.

In the image forming apparatus 100, by executing the programs, a job control unit 1511, an image reading unit 1512, a counting unit 1513, an acquisition unit 1514, a state detection unit 1515, an inference unit 1516, a determination unit 1517, and a display control unit 1518 are implemented.

The HDD 1204 of the image forming apparatus 100 includes the machine learning model 1204A, a data storage unit 1502, and a jam countermeasure table 1503.

It is assumed that the machine learning model 1204A is a learning model on which machine learning for inferring the cause of a sheet jam of the sheet 12 has been performed.

By inputting, to the machine learning model 1204A, the state of the sheet conveyor 18, the state of the sheet 12 on the conveyance path, and environmental information at the occurrence of the sheet jam, the machine learning model 1204A outputs an inference result of the cause of the sheet jam. A specific procedure of the machine learning using, for example, training data will be described later.

The state of the sheet conveyor 18 is indicated by, for example, information based on the assembly state of the sheet conveyor 18, component information of the sheet conveyor 18, and the detection result of the conveyance sensor 70. The information includes conveyance sensor information that includes information for specifying, for example, the position where the sheet jam of the sheet 12 occurs.

The assembly state of the sheet conveyor 18 is indicated by, for example, information on the states of the assemblies, which form the sheet conveyor 18, detected by the sensor group 1211. For example, the information indicating the assembly state includes the degree of wear of an assembly that can be specified based on information on an image captured by the camera 1212. The component information of the sheet conveyor 18 is information on the components forming the sheet conveyor 18. The information on the components includes, for example, the last replacement date and time of a component, the number of times of the use of the component, and the temperature of the component. The component information of the sheet conveyor 18 is stored in, for example, the HDD 1204 or the ROM 1203.

The information indicating the state of the sheet 12 on the conveyance path includes, for example, sheet size information indicating the size (detected by the conveyance sensor 70) of the sheet 12 that causes the sheet jam. The information indicating the state of the sheet 12 on the conveyance path further includes the sheet size set for performing printing on the sheet 12 on the conveyance path.

The information indicating the state of the sheet 12 on the conveyance path further includes sheet damage information indicating the degree of damage to the sheet 12 that causes the sheet jam, based on the information on the image captured by the camera 1212.

The environmental information includes, for example, information indicating the temperature and humidity around the sheet conveyor 18 detected by the temperature and humidity meter 1213.

The data storage unit 1502 is a storage area for storing the detection result of the sensor group 1211 disposed on the image forming apparatus 100 and data (e.g., image data) input or output to or from the image forming apparatus 100.

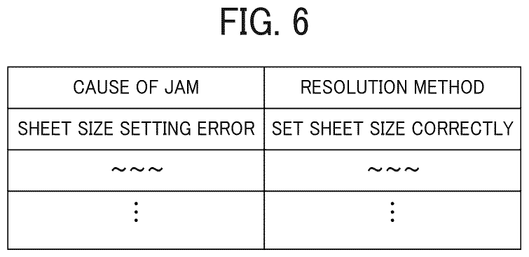

The jam countermeasure table 1503 according to the present embodiment is used to resolve the cause of a sheet jam when the sheet jam occurs. FIG. 6 is a diagram illustrating the table structure of the jam countermeasure table 1503 according to the present embodiment. As illustrated in FIG. 6, the jam countermeasure table 1503 according to the present embodiment stores a cause of a sheet jam and a resolution method for resolving the cause in association with each other. As illustrated in FIG. 6, when the cause of a sheet jam that occurs in the image forming apparatus 100 is a “sheet size setting error,” the user can resolve the cause of the sheet jam by “setting the sheet size correctly” as a resolution method.

The job control unit 1511 performs a basic function of the image forming apparatus 100 such as copying, facsimile communication, or printing according to an operation performed by the user. The job control unit 1511 has functions of exchanging an instruction among multiple software components and controlling transmission and reception of data when performing the basic function.

The image reading unit 1512 has a function of performing an operation of reading a document with a reading device included in the image forming apparatus 100 when a function of copying or scanning is performed based on an instruction from the job control unit 1511. Specifically, the image reading unit 1512 performs control for optically reading the contents of the document using an in-line sensor included in the reading device.

The counting unit 1513 records and manages various counter values (e.g., the total number of printed sheets) in the image forming apparatus 100.

The acquisition unit 1514 acquires the detection result from, for example, the sensor group 1211. The acquisition unit 1514 also acquires the current settings of the image forming apparatus 100. The detection result acquired from the sensor group 1211 includes, for example, the detection result of the sheet 12 detected by the conveyance sensor 70, the information on the image of the sheet 12 captured by the camera 1212, and the measurement result of the temperature and humidity measured by the temperature and humidity meter 1213. The current settings include, for example, the sheet size set by the user.

The state detection unit 1515 detects (acquires) the state of each component included in the image forming apparatus 100 based on the detection result acquired by the acquisition unit 1514 from, for example, the sensor group 1211 and the current settings. For example, based on the detection result of the conveyance sensor 70, the state detection unit 1515 determines whether a sheet jam of the sheet 12 has occurred and acquires the position where the sheet jam has occurred.

The state detection unit 1515 also acquires, based on the detection result acquired by the acquisition unit 1514 from, for example, the sensor group 1211 and the current settings, the state of the sheet conveyor 18, the state of the sheet 12 on the conveyance path, and the environmental information. The information indicating the state of the sheet conveyor 18 includes the assembly state of the sheet conveyor 18, the component information of the sheet conveyor 18, and the conveyance sensor information. The information indicating the state of the sheet 12 on the conveyance path includes the sheet size set in the print setting, the sheet size information identified based on the detection result of the conveyance sensor 70, and the sheet damage information. The environmental information includes the temperature and humidity around the sheet conveyor 18.

The state detection unit 1515 causes the data storage unit 1502 to store, for example, the information indicating the state of the sheet conveyor 18, the information indicating the state of the sheet 12 on the conveyance path, and the environmental information. The pieces of information caused to be stored by the state detection unit 1515 are not limited to the information indicating the state of the sheet conveyor 18, the information indicating the state of the sheet 12 on the conveyance path, and the environmental information, and may include, for example, the detection result detected by the sensor group 1211, or various settings and status information of the image forming apparatus 100.

When a sheet jam occurs in the image forming apparatus 100, the inference unit 1516 inputs the information caused to be stored by the state detection unit 1515 (for example, the assembly state of the sheet conveyor 18, the component information of the sheet conveyor 18, the conveyance sensor information, the sheet size set in the print setting, the sheet size information identified based on the detection result of the conveyance sensor 70, the sheet damage information, and the environmental information) to the machine learning model 1204A to receive an inference result of the cause of the sheet jam from the machine learning model 1204A. The inference unit 1516 performs inference processing using the machine learning model 1204A based on, for example, an instruction from the job control unit 1511. In the present embodiment, the assembly state of the sheet conveyor 18, the component information of the sheet conveyor 18, the conveyance sensor information, the sheet size set in the print setting, the sheet size information identified based on the detection result of the conveyance sensor 70, the sheet damage information, and the environmental information are input to the machine learning model 1204A. However, all the pieces of information do not need to be input to the machine learning model 1204A, and at least one or more of the pieces of information may be input to the machine learning model 1204A.

The inference unit 1516 performs the inference processing using the machine learning model 1204A and classification processing to implement an AI function for inferring the cause of a sheet jam.

The determination unit 1517 determines, in accordance with an instruction from the job control unit 1511, a resolution method for resolving the cause of the sheet jam based on the inference result provided by the inference unit 1516. For example, the determination unit 1517 refers to the jam countermeasure table 1503 to specify a resolution method that is associated with the cause of the sheet jam determined based on the inference result.

The display control unit 1518 performs control for displaying the resolution method on the display 1205 in accordance with an instruction from the job control unit 1511. For example, when a sheet jam occurs, the display control unit 1518 performs control for displaying information indicating the cause of the sheet jam inferred by the inference unit 1516 and the resolution method for resolving the cause determined by the determination unit 1517 on the display 1205. In the present embodiment, by displaying the information, the image forming system 1 can provide a suggestion of a resolution method to the user.

Similarly, in the data server 105, programs are stored in the HDD 1304. The CPU 1301 loads the stored programs onto the RAM 1302 and executes the programs.

In the data server 105, by executing the programs, a data collecting unit 1521 and a data providing unit 1522 are implemented. The HDD 1304 of the data server 105 includes a data storage unit 1523.

The data collecting unit 1521 receives (collects) data including information unique to a user environment relating to the image forming apparatus 100 from the image forming apparatus 100. The information unique to the user environment relating to the image forming apparatus 100 includes, for example, the data stored in the data storage unit 1502 of the image forming apparatus 100. The data collecting unit 1521 receives (collects) the data from one or more image forming apparatuses 100.

The data storage unit 1523 is a storage area for storing the information collected by the data collecting unit 1521.

The data providing unit 1522 transmits (provides) the information stored in the data storage unit 1523, which is collected by the data collecting unit 1521, to the machine learning server 102.

In the machine learning server 102, programs are stored in the HDD 1304. The CPU 1301 loads the stored programs onto the RAM 1302 and executes the programs. The stored programs may be executed by the GPU 1306 in addition to the CPU 1301.

In the machine learning server 102, by executing the programs, a training data generation unit 1531 and the machine learning unit 1532 are implemented. The HDD 1304 of the machine learning server 102 includes a data storage unit 1533.

The data storage unit 1533 is a storage area for storing the information received from the data server 105. Also, the data storage unit 1533 is a storage area for storing the training data generated by the training data generation unit 1531.

The training data generation unit 1531 generates training data to be used for machine learning, using information stored in the data storage unit 1533, which is received from the data server 105.

The training data generation unit 1531 removes data that becomes noise from the information stored in the data storage unit 1533, which is received from the data server 105, in order to obtain a desired learning effect. Any known technique may be used for removing the data that becomes noise.

In addition, the training data generation unit 1531 performs adjustment on the generated training data according to the format of data to be input to the machine learning model to optimize the generated training data as training data. For example, as an example of the preprocessing for effectively performing machine learning, the training data generation unit 1531 may extract the assembly state of the sheet conveyor 18, the component information of the sheet conveyor 18, the conveyance sensor information immediately after the occurrence of a sheet jam, the sheet size set in the print setting, the sheet size information identified based on the detection result of the conveyance sensor 70, the sheet damage information, and the environmental information from the information received from the data server 105, and may include the extracted information in the training data. By extracting the pieces of information and including the pieces of information in the training data, efficient learning of the cause of the sheet jam is achieved.

Furthermore, the training data generation unit 1531 associates the extracted information with information indicating the cause of the sheet jam to generate training data. Accordingly, in the training data, the assembly state of the sheet conveyor 18, the state of the sheet 12 on the conveyance path, the environmental information are associated with the cause of the sheet jam. It is assumed that the cause of the sheet jam is the information input by a service representative or analyst who has handled the sheet jam.

The machine learning unit 1532 performs machine learning based on the training data to generate a machine learning model. The machine learning model is generated by applying supervised learning based on the training data to a neural network that serves as a base. A specific generation method will be described later.

The machine learning model generated by the machine learning server 102 is stored in the HDD 1204 of the image forming apparatus 100. The machine learning model is a kind of calculation algorithm, and is modularized as a part of the control program of the image forming apparatus 100 and stored in the HDD 1204.

A procedure for inferring the cause of a sheet jam in the image forming system 1 according to the present embodiment is described below.

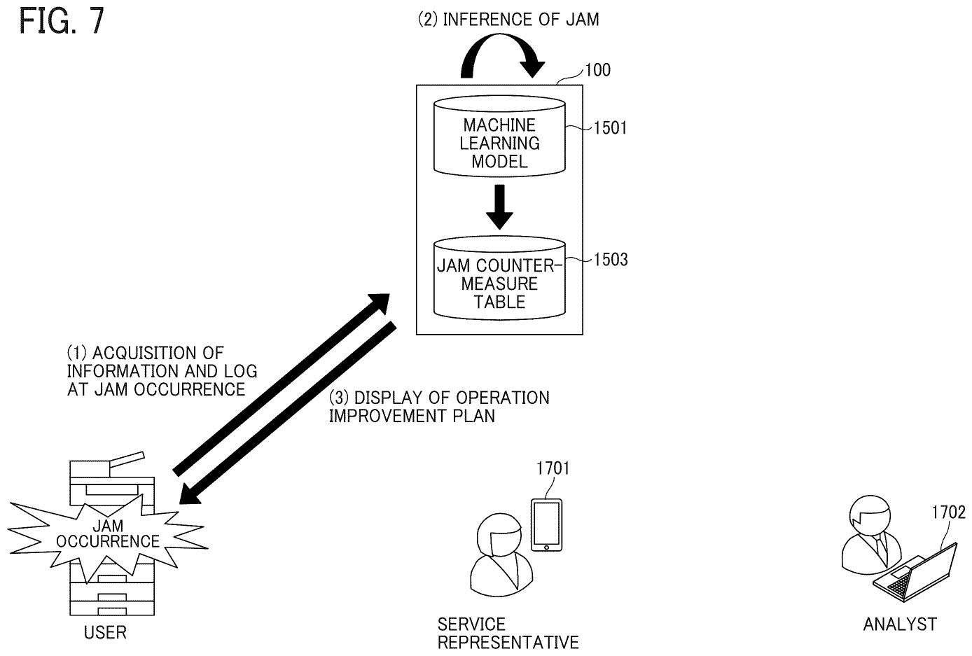

FIG. 7 is a diagram illustrating an example of a procedure for inferring the cause of a sheet jam in the image forming system 1 according to the present embodiment. In FIG. 7, the service representative and the analyst are illustrated. The service representative visits the user and performs maintenance when a sheet jam occurs. The analyst analyzes the cause of the sheet jam in response to a request from the service representative. The service representative may have a communication terminal 1701 for communication, and the analyst may have an information processing apparatus 1702 for analyzing the cause of the sheet jam and communicating with the service representative.

When a sheet jam occurs, the service representative conventionally visits the user and takes a measure to resolve the cause of the sheet jam. The service representative requests the analyst to analyze the cause as necessary. In this case, the service representative takes a measure to resolve the cause according to the analysis result received from the analyst.

In contrast, the image forming system 1 according to the present embodiment uses the AI function of the image forming apparatus 100 to infer the cause of the sheet jam without requesting the analyst to perform the analysis.

First, a sheet jam occurs in the sheet conveyor 18 of the image forming apparatus 100. The acquisition unit 1514 of the image forming apparatus 100 acquires the detection result, for example, from the sensor group 1211 when the sheet jam occurs, and a log indicating, for example, the current settings (see (1) in FIG. 7). The state detection unit 1515 extracts, from the acquired information, as information indicating the state of the sheet conveyor 18 and the state of the sheet 12 on the conveyance path, the assembly state of the sheet conveyor 18, the component information of the sheet conveyor 18, the conveyance sensor information immediately after the occurrence of the sheet jam, the sheet size set in the print setting, the sheet size information identified based on the detection result of the conveyance sensor 70, the sheet damage information, and the environmental information.

The inference unit 1516 infers the cause of the sheet jam based on the extracted information (see (2) in FIG. 7). Specifically, the inference unit 1516 inputs the information extracted by the state detection unit 1515 to the machine learning model 1204A to receive an inference result of the cause of the sheet jam. In the example illustrated in FIG. 7, it is assumed that the sheet jam is inferred to be caused by an operation error.

The determination unit 1517 refers to the jam countermeasure table 1503 to determine a resolution method for resolving the cause of the sheet jam. In FIG. 7, it is assumed that the cause of the sheet jam can be resolved by an operation performed by the user according to the resolution method determined by the determination unit 1517.

The display control unit 1518 performs control for displaying an improvement plan of the operation in which the cause of the sheet jam and the resolution method are associated with each other on the display 1205 (see (3) in FIG. 7). The cause of the sheet jam is resolved by the user performing an operation according to the improvement plan displayed on the display. Thus, the user does not need to contact the service representative.

The technique in the related art is for performing maintenance before a sheet jam occurs. When a sheet jam occurs, the same work as in the related art, such as investigation of the cause of the sheet jam, is required. However, according to the one aspect of the present disclosure, since the work of the service representative and the analyst is not required, the workload for the service representative and the analyst can be reduced.

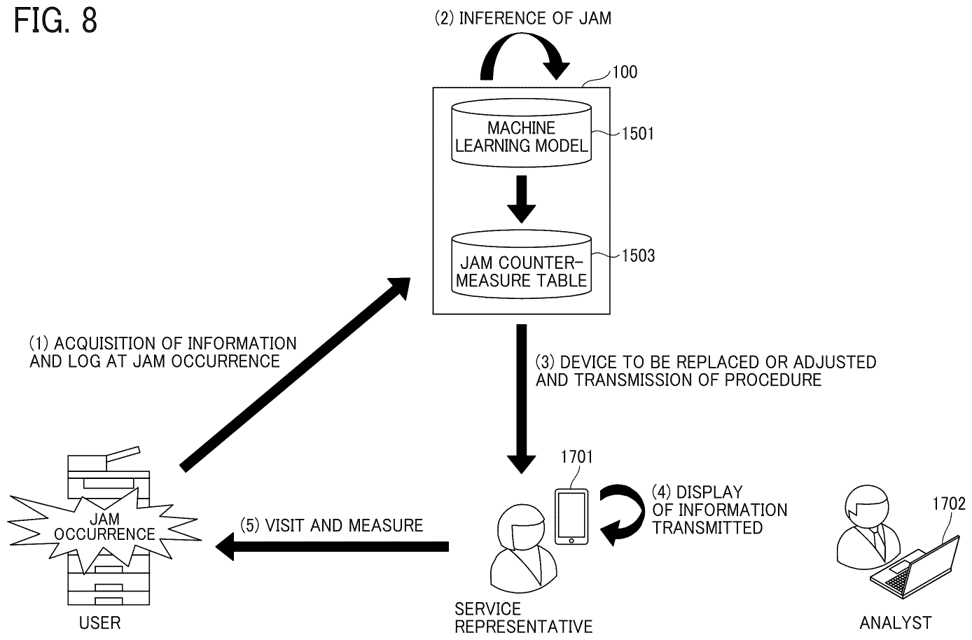

FIG. 8 is a diagram illustrating another example of a procedure for inferring the cause of a sheet jam in the image forming system 1 according to the present embodiment. In FIG. 8, the service representative and the analyst are illustrated. The service representative visits the user and performs maintenance when a sheet jam occurs. The analyst analyzes the cause of the sheet jam in response to a request from the service representative. The service representative may have the communication terminal 1701 for communication, and the analyst may have the information processing apparatus 1702 for analyzing the cause of the sheet jam and communicating with the service representative.

First, a sheet jam occurs in the sheet conveyor 18 of the image forming apparatus 100. The acquisition unit 1514 of the image forming apparatus 100 acquires the detection result, for example, from the sensor group 1211 when the sheet jam occurs, and a log indicating, for example, the current settings (see (1) in FIG. 8). The state detection unit 1515 extracts, from the acquired information, as information indicating the state of the sheet conveyor 18 and the state of the sheet 12 on the conveyance path, the assembly state of the sheet conveyor 18, the component information of the sheet conveyor 18, the conveyance sensor information immediately after the occurrence of the sheet jam, the sheet size set in the print setting, the sheet size information identified based on the detection result of the conveyance sensor 70, the sheet damage information, and the environmental information.

The inference unit 1516 infers the cause of the sheet jam based on the extracted information (see (2) in FIG. 8). Specifically, the inference unit 1516 inputs the information extracted by the state detection unit 1515 to the machine learning model 1204A to receive an inference result of the cause of the sheet jam. In the example illustrated in FIG. 8, it is assumed that the sheet jam is inferred to be caused by a failure in a device. In this case, the service representative needs to visit the user but the analyst does not need to analyze the cause of the sheet jam.

The determination unit 1517 refers to the jam countermeasure table 1503 to determine a resolution method for resolving the cause of the sheet jam. In FIG. 8, it is assumed that the cause of the sheet jam can be resolved by replacing or adjusting the device according to the resolution method determined by the determination unit 1517. The resolution method includes information indicating the device to be replaced or adjusted and a procedure for replacing or adjusting the device. The determination unit 1517 may switch contacts depending on the resolution method. In the example illustrated in FIG. 8, the determination unit 1517 determines the contact to be the service representative.

The job control unit 1511 of the image forming apparatus 100 transmits, together with information indicating the occurrence of the sheet jam in the image forming apparatus 100, information indicating the device to be replaced or adjusted and a procedure for replacing or adjusting the device to the communication terminal 1701 of the service representative (see (3) in FIG. 8).

The display control unit 1518 may perform control for displaying, on the display 1205, the occurrence of the sheet jam and the contact with the service representative, in accordance with an instruction from the job control unit 1511.

The communication terminal 1701 of the service representative displays, based on the information received from the job control unit 1511, the information indicating the device to be replaced or adjusted and the procedure for replacing or adjusting the device, together with information indicating the occurrence of the sheet jam in the image forming apparatus 100 (see (4) in FIG. 8).

The service representative visits the user and takes a measure to replace or adjust the device that has caused the sheet jam in the image forming apparatus 100 (see (5) in FIG. 8). In the example illustrated in FIG. 8, the service representative visits the user after having recognized the cause of the sheet jam. Accordingly, even in the case where the device needs to be replaced, the service representative can prepare a device for replacement in advance. As a result, the service representative does not need to visit the user more than once, and the workload for the service representative can be reduced. Further, since the work of the analyst is not required, the workload for the analyst can also be reduced.

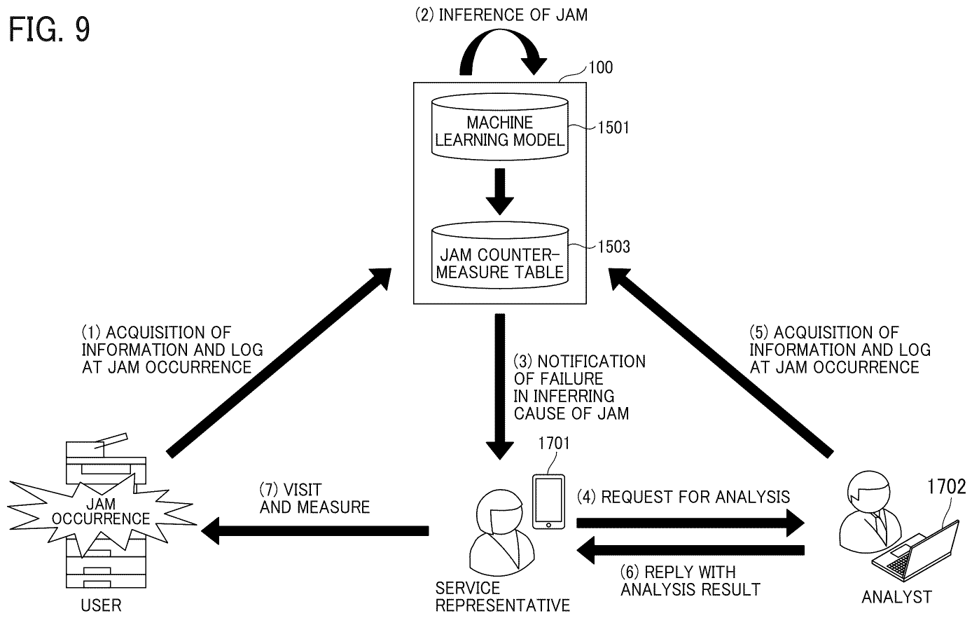

FIG. 9 is a diagram illustrating still another example of a procedure for inferring the cause of a sheet jam in the image forming system 1 according to the present embodiment. In FIG. 9, the service representative and the analyst are illustrated. The service representative visits the user and performs maintenance when a sheet jam occurs. The analyst analyzes the cause of the sheet jam in response to a request from the service representative. The service representative may have the communication terminal 1701 for communication, and the analyst may have the information processing apparatus 1702 for analyzing the cause of the sheet jam and communicating with the service representative.

First, a sheet jam occurs in the sheet conveyor 18 of the image forming apparatus 100. The acquisition unit 1514 of the image forming apparatus 100 acquires the detection result, for example, from the sensor group 1211 when the sheet jam occurs, and a log indicating, for example, the current settings (see (1) in FIG. 9). The state detection unit 1515 extracts, from the acquired information, as information indicating the state of the sheet conveyor 18 and the state of the sheet 12 on the conveyance path, the assembly state of the sheet conveyor 18, the component information of the sheet conveyor 18, the conveyance sensor information immediately after the occurrence of the sheet jam, the sheet size set in the print setting, the sheet size information identified based on the detection result of the conveyance sensor 70, the sheet damage information, and the environmental information.

The inference unit 1516 infers the cause of the sheet jam based on the extracted information (see (2) in FIG. 9). Specifically, the inference unit 1516 inputs the information extracted by the state detection unit 1515 to the machine learning model 1204A to receive an inference result of the cause of the sheet jam. In the example illustrated in FIG. 9, it is assumed that the machine learning model 1204A fails to infer the cause of the sheet jam. For this reason, the determination unit 1517 prevents determining a resolution method for resolving the cause of the sheet jam. In addition, the determination unit 1517 determines the contact to be the service representative.

The job control unit 1511 of the image forming apparatus 100 transmits, together with information indicating the occurrence of the sheet jam in the image forming apparatus 100, information indicating the failure in inferring the cause of the sheet jam to the communication terminal 1701 of the service representative (see (3) in FIG. 9).

In response to an operation performed by the service representative, the communication terminal 1701 transmits an analysis request to the analyst (see (4) in FIG. 9).

In response to an operation performed by the analyst, the information processing apparatus 1702 of the analyst receives the information at the occurrence of the sheet jam and the log from the image forming apparatus 100 (see (5) in FIG. 9). The analyst analyzes the received information and log to determine the cause of the sheet jam.

The analyst reports (replies) the analysis result to the service representative (see (6) in FIG. 9).

The service representative visits the user and takes a measure in the image forming apparatus 100 according to the analysis result (see (7) in FIG. 9). The cause of the sheet jam is resolved by taking the measure.

The machine learning server 102 generates training data based on the information at the occurrence of the sheet jam and the log received from the image forming apparatus 100 and the cause of the sheet jam determined based on the analysis result provided by the analyst, and performs additional learning for the machine learning model using the generated training data. The image forming apparatus 100 stores the machine learning model additionally trained in the HDD 1204. As a result, by using the machine learning model additionally trained, the image forming system 1 can increase the probability of inferring the cause of a sheet jam that has failed to be inferred. Thus, the image forming apparatus 100 according to the present embodiment can increase the accuracy in inferring the cause of a sheet jam.

A specific procedure of inferencing using the machine learning model 1204A is described below. By inputting the sheet size set in the print setting and the sheet size identified based on the detection result of the conveyance sensor 70 to the machine learning model 1204A of the present embodiment, the machine learning model 1204A infers the cause of a sheet jam. The inference of the cause of a sheet jam performed by the machine learning model 1204A based on the sheet size is described.

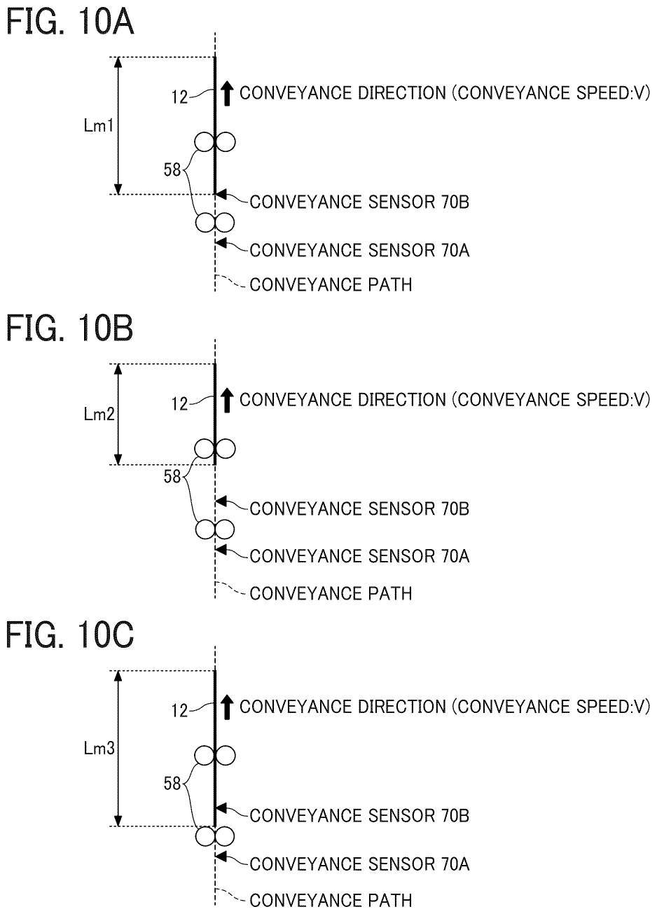

FIGS. 10A to 10C are diagrams each illustrating how the cause of a sheet jam is inferred based on the sheet size set in the print setting and the sheet size calculated based on the detection result of the conveyance sensor 70.

In the example of FIG. 10A, the length of a sheet in the conveyance direction in the print setting for the processing of image formation is defined as Lm1 (meters [m]), and the conveyance speed of the sheet 12 on the conveyance path is defined as V (seconds per meter [sec/m]). Among the conveyance sensors 70, one located upstream is referred to as a conveyance sensor 70A and another located downstream is referred to as a conveyance sensor 70B.

As the sheet conveyor 18 controls the rotation of the conveyance roller pairs 58, the trailing end of the sheet 12 is expected to reach the conveyance sensor 70B after Lm1/V seconds elapses since the leading end of the sheet 12 passes the conveyance sensor 70B.

For the image forming apparatus 100 according to the present embodiment, time margins Ta (seconds [sec]) and Tb [sec] are set to detect the occurrence of a sheet jam.

In other words, when the conveyance sensor 70B does not detect the trailing end of the sheet 12 during a time period from “Lm1/V−Ta” [sec] to “Lm1/V+Tb” [sec] in consideration of the time margins after the conveyance sensor 70B detects the leading end of the sheet 12, the state detection unit 1515 of the image forming apparatus 100 determines that a sheet jam has occurred and the job control unit 1511 stops the printing process.

In addition, a time from when the conveyance sensor 70A located upstream of the conveyance sensor 70B detects the leading end of the sheet 12 to when the conveyance sensor 70A detects the trailing end of the sheet 12 is defined as Tm [sec]. When the time Tm [sec] is acquired, the state detection unit 1515 detects the length of the sheet in the conveyance direction, which is defined as V×Tm [m].

In FIG. 10B, an example is illustrated in which the state detection unit 1515 determines that a sheet jam has occurred because a time from when the conveyance sensor 70B detects the leading end of the sheet 12 to when the conveyance sensor 70B detects the trailing end of the sheet 12 is shorter than the time “Lm1/V−Ta” [sec].

In the example of FIG. 10B, the length of a sheet in the conveyance direction in the print setting is defined as Lm1 [m]. On the other hand, the state detection unit 1515 calculates the length of the sheet, which is defined as Lm2 [m], based on a time from when the conveyance sensor 70A detects the leading end of the sheet 12 to when the conveyance sensor 70A detects the trailing end of the sheet 12.

In this case, the inference unit 1516 inputs the sheet length Lm1 in the conveyance direction in the print setting and the sheet size Lm2 calculated based on the detection result of the conveyance sensor 70A to the machine learning model 1204A to receive an inference result that the sheet size set in the print setting and the actual sheet size do not match (the actual sheet size is smaller) as the cause of the sheet jam.

In FIG. 10C, an example is illustrated in which the state detection unit 1515 determines that a sheet jam has occurred because a time from when the conveyance sensor 70B detects the leading end of the sheet 12 to when the conveyance sensor 70B detects the trailing end of the sheet 12 is longer than the time “Lm1/V−Tb” [sec].

In the example of FIG. 10C, the length of a sheet in the conveyance direction in the print setting is defined as Lm1 [m]. On the other hand, the state detection unit 1515 calculates the length of the sheet, which is defined as Lm3 [m], based on a time from when the conveyance sensor 70A detects the leading end of the sheet 12 to when the conveyance sensor 70A detects the trailing end of the sheet 12.

In this case, the inference unit 1516 inputs the sheet length Lm1 in the conveyance direction in the print setting and the sheet size Lm3 calculated based on the detection result of the conveyance sensor 70A to the machine learning model 1204A to receive an inference result that the sheet size set in the print setting and the actual sheet size do not match (the actual sheet size is longer) as the cause of the sheet jam.

In the examples of FIGS. 10B and 10C, the determination unit 1517 refers to the jam countermeasure table to determine “set the sheet size correctly” as a resolution method.

The display control unit 1518 performs control for displaying the cause of the sheet jam and the resolution method on the display 1205.

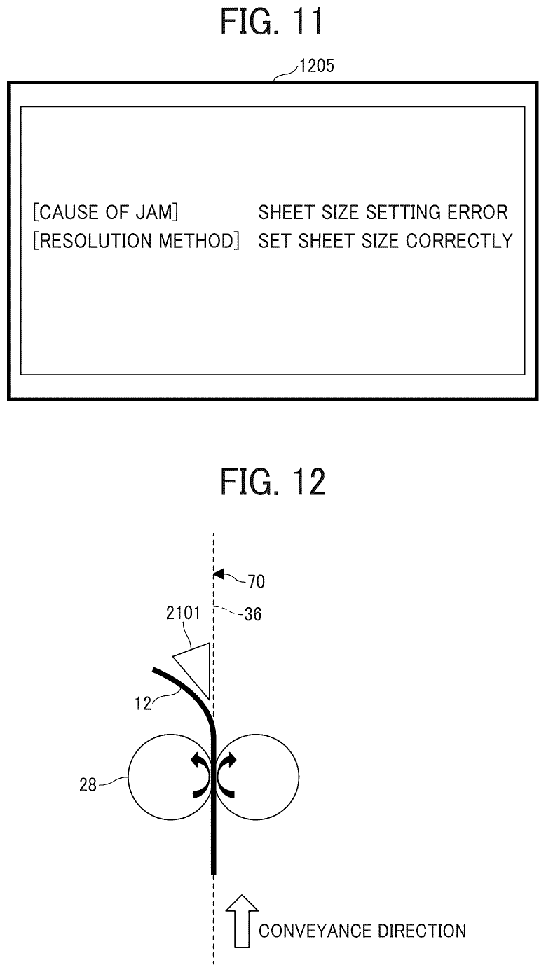

FIG. 11 is a diagram illustrating a screen displayed on the display 1205 by the display control unit 1518 according to the present embodiment. In the screen illustrated in FIG. 11, a “sheet size setting error” is presented as the cause of the sheet jam, and “set the sheet size correctly” is presented as a resolution method for resolving the cause of the sheet jam. By referring to the screen, the user can correctly set the sheet size and resolve the cause of the sheet jam.

In the present embodiment, since the cause of a sheet jam and the resolution method for resolving the cause of the sheet jam are associated with each other in the jam countermeasure table, the resolution method for resolving the cause of the sheet jam is notified to the user after the cause of the sheet jam is inferred. The user can take an appropriate measure according to the display of the screen as illustrated in FIG. 11.

Subsequently, the inference of the cause of a sheet jam performed by the machine learning model 1204A based on the environmental information is described. In the image forming process in a low temperature or high humidity environment, dew condensation may occur in the image forming apparatus 100. When dew condensation occurs on a component of the conveyance path in the image forming apparatus 100, the sheet 12 being conveyed may stick to the component, and the conveyance speed of the sheet 12 may decrease.

The state detection unit 1515 of the image forming apparatus 100 determines that a sheet jam has occurred when the arrival of the sheet 12 is not detected as expected based on the detection result of the conveyance sensor 70.

In this case, the inference unit 1516 inputs the environmental information including the temperature and humidity detected by the temperature and humidity meter 1213 to the machine learning model 1204A to receive an inference result that dew condensation is the cause of the sheet jam.

In this case, the determination unit 1517 refers to the jam countermeasure table to determine “increase the temperature or decrease the humidity in the room” as a resolution method. Accordingly, the user can resolve the cause of the sheet jam by operating the air conditioner in the environment (for example, a room) where the image forming apparatus 100 is located to increase the temperature or decrease the humidity in the environment.

Subsequently, the inference of the cause of a sheet jam performed by the machine learning model 1204A based on the sheet damage information is described.

FIG. 12 is a diagram illustrating the cause of a sheet jam determined based on the sheet damage information. In FIG. 12, the image forming apparatus 100 is in the processing of image formation and the sheet 12 is passing through the fixing roller pair 28. When the fixing roller pair 28 illustrated in FIG. 12 is at a high temperature, the sheet 12 that has passed through the fixing roller pair 28 may curl. In the example of FIG. 12, the sheet 12 that has curled is caught by a component 2101 located downstream of the fixing roller pair 28 and is not conveyed along the ejecting conveyance path 36.

In this case, the state detection unit 1515 of the image forming apparatus 100 determines that a sheet jam has occurred since the arrival of the sheet 12 is not detected as expected based on the detection result of the conveyance sensor 70 located downstream of the fixing roller pair 28.

In this case, the inference unit 1516 inputs the sheet damage information based on the information on the image captured by the camera 1212 disposed on the ejecting conveyance path 36 to the machine learning model 1204A to receive an inference result that the fixing temperature is high as the cause of the sheet jam.

The determination unit 1517 refers to the jam countermeasure table to determine “decrease the fixing temperature to a degree at which the sheet does not curl” as the resolution method. The service representative can resolve the cause of the sheet jam by taking a measure to decrease the fixing temperature of the fixing roller pair 28.

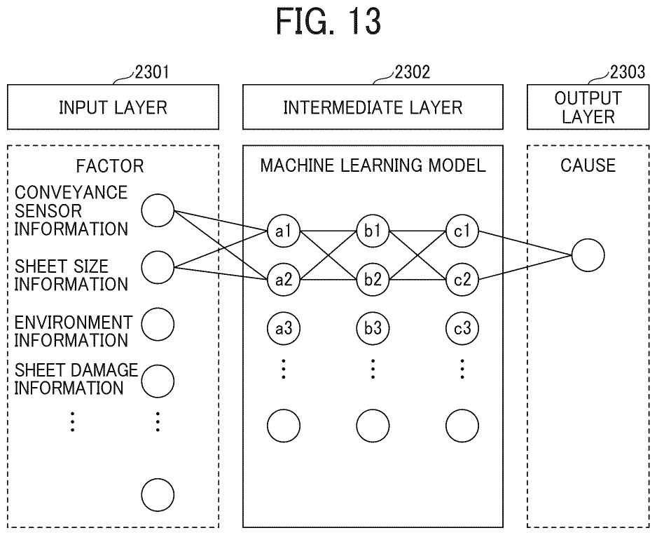

FIG. 13 is a diagram illustrating the structure of a machine learning model generated by the machine learning server 102 according to the present embodiment. As illustrated in FIG. 13, the machine learning model causes a computer to function so as to output the cause of a sheet jam based on information on sheet jam factors in the image forming apparatus 100. In FIG. 13, an example is illustrated in which the machine learning model uses a neural network.

The machine learning model is configured as a neural network including an input layer 2301, an intermediate layer 2302, and an output layer 2303. In the example of FIG. 13, the machine learning model inputs information such as the conveyance sensor information, the sheet size information (including the sheet size set in the print setting and the sheet size calculated based on the detection result of the conveyance sensor 70), the environment information, and the sheet damage information to the input layer 2301 as sheet jam factors. The information to be input to the machine learning model may include the assembly state of the sheet conveyor 18 and the component information of the sheet conveyor 18. In the machine learning model, a weight coefficient is machine-learned for each element of the intermediate layer 2302 so that an inference result of the cause of a sheet jam is output from the output layer 2303 based on the input information.

In FIG. 13, an example of factors related to the occurrence of a sheet jam is illustrated, but the factors are not limited to those illustrated in FIG. 13. For example, the detection result from the sensor group 1211 disposed in the image forming apparatus 100 may be used as a factor related to the occurrence of a sheet jam.

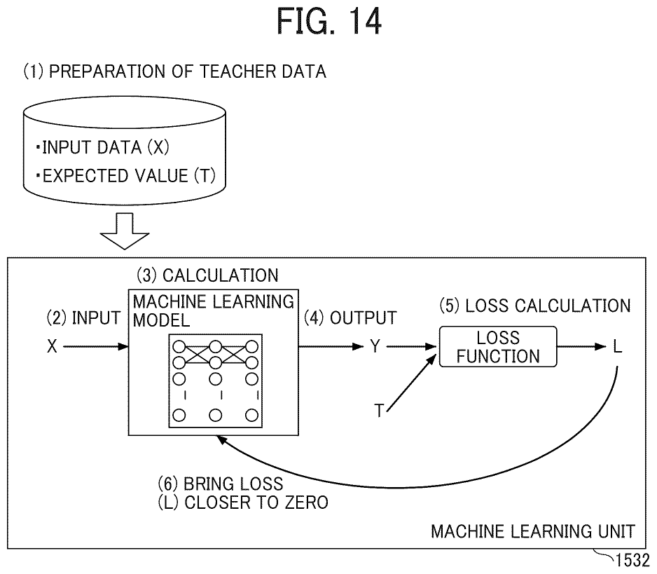

FIG. 14 is a conceptual diagram illustrating the machine learning performed by the machine learning unit 1532 of the machine learning server 102 according to the present embodiment. As illustrated in FIG. 14, the training data generation unit 1531 prepares (generates) a large number of pieces of training data to be used for the machine learning in advance (see (1) in FIG. 14).

Input data X included in the training data includes the assembly state of the sheet conveyor 18, the component information of the sheet conveyor 18, the conveyance sensor information, the sheet size information (including the sheet size set in the print setting and the sheet size calculated based on the detection result of the conveyance sensor 70), the sheet damage information, and the environmental information, which are input to the input layer 2301 as the sheet jam factors. The input data X is assumed to be data whose correct value is known. An expected value T included in the training data is assumed to be the cause of a sheet jam. The expected value T is a correct value corresponding to the input data.

Examples of a specific method of the machine learning include a nearest neighbor method, a naive Bayes method, a decision tree, and a support vector machine, in addition to the neural network. Another example is deep learning, which uses a neural network to generate a feature value and a coupling weight coefficient for learning. Any of the above methods (algorithms) that are available may be applied to the present embodiment as appropriate.

When the input data X included in the training data is input to the machine learning model, the machine learning unit 1532 adjusts the weight coefficient of the machine learning model so that output data Y to be output becomes as close as possible to the expected value T corresponding to the input data X.

The machine learning unit 1532 has functions as an error detection unit and an updating unit. Specifically, when the machine learning unit 1532 inputs the input data X to the input layer (see (2) in FIG. 14), calculations are performed by the machine learning model (see (3) in FIG. 14). Then, the machine learning unit 1532 receives the output data Y from the output layer as the result of the machine learning model (see (4) in FIG. 14). The machine learning unit 1532, as the error detection unit, uses a loss function to calculate a loss L that represents the magnitude of the deviation between the output data Y and the expected value T of the training data (see (5) in FIG. 14).

The machine learning unit 1532, as the updating unit, updates, for example, the coupling weight coefficient among the nodes of the neural network based on the loss L so that the loss L becomes smaller (so that the loss L is brought close to zero) (see (6) in FIG. 14).

The machine learning unit 1532 uses, for example, an error backpropagation method as an algorithm for learning the neural network, but may use another method.

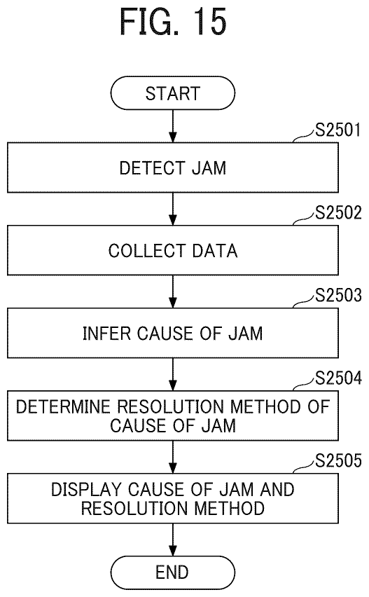

FIG. 15 is a flowchart of the processing at the occurrence of a sheet jam in the image forming apparatus 100 according to a first embodiment.

In S2501, the state detection unit 1515 of the image forming apparatus 100 detects an occurrence of a sheet jam based on the detection result acquired by the acquisition unit 1514 from, for example, the sensor group 1211 and the current settings.

In S2502, the state detection unit 1515 collects data indicating the state of each component included in the image forming apparatus 100 at the occurrence of the sheet jam based on the detection result acquired by the acquisition unit 1514 from, for example, the sensor group 1211 and the current settings, and causes the data to be stored in the data storage unit 1502.

In S2503, the inference unit 1516 uses the machine learning model 1204A to infer the cause of the sheet jam. Specifically, the inference unit 1516 inputs the data stored in the data storage unit 1502 to the machine learning model 1204A to receive an inference result of the cause of the sheet jam from the machine learning model 1204A.

In S2504, the determination unit 1517 refers to the jam countermeasure table 1503 to determine a resolution method for resolving the cause of the sheet jam based on the inference result of the cause of the sheet jam provided by the inference unit 1516.

In S2505, the display control unit 1518 performs control for displaying information indicating the cause of the sheet jam inferred by the inference unit 1516 and the resolution method for resolving the cause of the sheet jam determined by the determination unit 1517 on the display 1205.

In the present embodiment, by referring to the information displayed on the display 1205, the user can recognize the resolution method for resolving the cause of the sheet jam. By the user taking a measure to resolve the cause of the sheet jam, the downtime of the image forming apparatus 100 is shortened. In addition, since there is no need to call the service representative, the workload for the service representative is reduced.

The image forming apparatus 100 according to the present embodiment uses the AI function to infer the cause of a sheet jam. When the image forming apparatus 100 infers the cause of the sheet jam, the accuracy of the inference of the cause of the sheet jam can be increased by using various types of information such as the sheet size set in the print setting at the occurrence of the sheet jam, the sheet size detected by the apparatus, the environmental information, and the sheet damage information. In addition, the cause of the occurrence of the sheet jam can be resolved without waiting for the service representative to visit the user or for the analyst to analyze the data. As a result, the image forming apparatus 100 according to the present embodiment can shorten downtime.

In the present embodiment, the image forming apparatus 100 includes the acquisition unit 1514, the state detection unit 1515, the inference unit 1516, the storage device (HDD 1204) storing the jam countermeasure table 1503, the display control unit 1518, the display 1205, and the sheet conveyor 18. However, in the present embodiment, the configuration of the image forming apparatus 100 is not limited to the configuration described above. For example, the display control unit 1518 and the display 1205 may be implemented in a mobile terminal owned by the user, or the storage device (HDD 1204) storing the jam countermeasure table 1503 and the inference unit 1516 may be implemented in an information processing apparatus communicable with the image forming apparatus 100. Further, the acquisition unit 1514 and the state detection unit 1515 may be implemented in a diagnostic apparatus communicable with the image forming apparatus 100. In this way, the inference system may be implemented by a combination of multiple apparatuses.

### Second Embodiment

In the above-described embodiment, the data server 105 and the machine learning server 102 are included in the image forming apparatus 100. However, the above-described embodiment is not limited to a case where the data collection and the learning and inference phases are performed by separate apparatuses. For example, the image forming apparatus may have a function of collecting data and a function of generating a machine learning model.

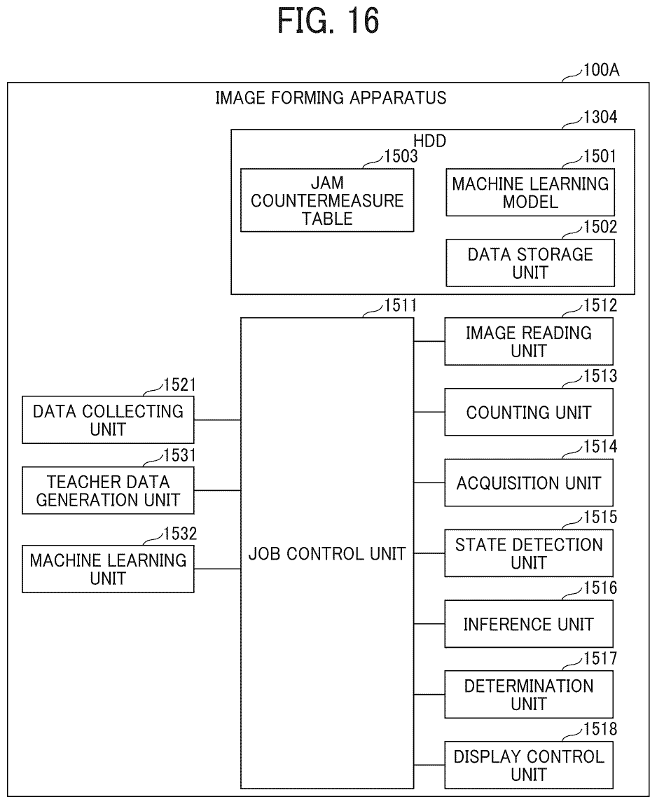

FIG. 16 is a block diagram illustrating a software configuration of an image forming apparatus 100A according to the present embodiment. In FIG. 16, a software configuration implemented by using the hardware resources illustrated in FIG. 3 included in the image forming apparatus 100A according to the present embodiment and programs is illustrated.

As illustrated in FIG. 16, the image forming apparatus 100A according to the present embodiment further includes, in addition to the configuration of the image forming apparatus 100 illustrated in FIG. 5, the data collecting unit 1521 that collects data to be used for training data, the training data generation unit 1531 that generates training data, and the machine learning unit 1532 that generates a machine learning model.

The image forming apparatus 100A includes the data collecting unit 1521, the training data generation unit 1531, and the machine learning model, so as to collect data when a sheet jam occurs, generate training data, and generate and update the machine learning model based on the training data. The specific processing performed by each element is substantially the same as that described in the above-described embodiment. Identical or similar reference signs are given to elements similar to those illustrated in the above-described embodiment and overlapping description may be simplified or omitted as appropriate.

### Third Embodiment

In the above-described embodiment, an example is described in which the image forming apparatus 100 includes the machine learning model 1204A and executes the AI function. However, the above-described embodiment is not limited to a case where the image forming apparatus 100 executes the AI function.

For example, a cloud server communicable with the image forming apparatus 100 may be an inference apparatus that executes the AI function. For example, the CPU 1201 of the image forming apparatus 100 transmits, to the cloud server, information for detecting a sheet jam of the sheet 12 on the conveyance path, the assembly state of the sheet conveyor 18, the component information of the sheet conveyor 18, the conveyance sensor information immediately after the occurrence of the sheet jam, the sheet size set in the print setting, the sheet size information identified based on the detection result of the conveyance sensor 70, the sheet damage information, and the environmental information.

When the cloud server receives the information from the image forming apparatus 100, the cloud server determines that a sheet jam has occurred in the image forming apparatus 100. The cloud server infers the cause of the sheet jam based on the received information. The cloud server determines a resolution method corresponding to the cause of the sheet jam. The method for determining the resolution method is the same as that in the above-described embodiment.

The cloud server transmits the inference result of the cause of the sheet jam and the resolution method for resolving the cause of the sheet jam to the image forming apparatus 100. Then, the image forming apparatus 100 displays the inference result of the cause of the sheet jam and the resolution method for resolving the cause of the sheet jam on the display 1205.

The present embodiment provides the same effects as those in the first embodiment described above. In addition, since the image forming apparatus 100 does not need to perform the inference phase, the computation load for the apparatus can be reduced.

In the above-described embodiments, when a sheet jam occurs, the image forming apparatus or the cloud server infers the cause of the sheet jam. Accordingly, the workload for identifying the cause of the sheet jam is reduced. Furthermore, an operator such as the user can immediately use the image forming apparatus by resolving the cause of the sheet jam based on the identified cause of the sheet jam. Accordingly, the downtime of the image forming apparatus is shortened.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. The respective elements included in the above-described specific examples can be appropriately combined as long as there is no technical contradiction.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disc (DVD), and/or the memory of an FPGA or ASIC.

1. An inference apparatus comprising:
a sheet jam detector to detect occurrence of a jam of a sheet on a conveyance path in a case that the sheet is conveyed along the conveyance path by an operation of a sheet conveyor; and
circuitry configured to:
acquire information indicating a state of the sheet conveyor and a state of the sheet on the conveyance path in a case that the occurrence of the jam is detected;
input information indicating at least one of the state of the sheet conveyor or the state of the sheet on the conveyance path to a learning model, the learning model being generated by performing machine learning to infer a cause of the jam of the sheet; and
receive an inference result of the cause of the jam from the learning model.

2. The inference apparatus according to claim 1, wherein the circuitry is further configured to:
acquire, as the state of the sheet on the conveyance path, a sheet size set for printing on the sheet and a size of the sheet identified based on a detection result from the sheet jam detector; and
input, to the learning model, information indicating the sheet size set for printing on the sheet and the size of the sheet identified based on the detection result to receive the inference result of the cause of the jam from the learning model.

3. The inference apparatus according to claim 1, further comprising an environment detection device to detect information indicating an environment in which the sheet conveyor is disposed,
wherein the circuitry is configured to further input, to the learning model, the information indicating the environment in which the sheet conveyor is disposed to receive the inference result of the cause of the jam from the learning model.

4. The inference apparatus according to claim 1, further comprising a sheet state detection device to detect, as the state of the sheet on the conveyance path, a degree of damage of the sheet being conveyed along the conveyance path in a case that the occurrence of the jam is detected,
wherein the circuitry is configured to input, to the learning model, information indicating the degree of damage of the sheet to receive the inference result of the cause of the jam from the learning model.

5. The inference apparatus according to claim 1, wherein the circuitry is further configured to:
store, in a memory, a table associating the cause of the jam with a resolution method for resolving the cause; and
display, on a display, information indicating the cause of the jam received as the inference result and the resolution method associated with the cause of the jam in the table.

6. An inference system comprising:
an apparatus including:
a sheet conveyor to convey a sheet along a conveyance path;
apparatus circuitry; and
a sheet jam detector to detect occurrence of a jam of the sheet on the conveyance path; and
a server including system circuitry,
wherein the apparatus circuitry and the system circuitry operate in cooperation to:
acquire information indicating a state of the sheet conveyor and a state of the sheet on the conveyance path in a case that the occurrence of the jam is detected;
input information indicating at least one of the state of the sheet conveyor or the state of the sheet on the conveyance path to a learning model, the learning model being generated by performing machine learning to infer a cause of the jam of the sheet;
receive an inference result of the cause of the jam from the learning model;
store, in a memory, a table associating the cause of the jam with a resolution method for resolving the cause; and
display, on a display, information indicating the cause of the jam received as the inference result and the resolution method associated with the cause of the jam in the table.

7. A trained model generation apparatus comprising circuitry configured to perform machine learning using, as training data, data associating information indicating a state of a sheet conveyor and a state of a sheet on a conveyance path in a case that a jam of the sheet occurs on the conveyance path along which the sheet is conveyed by an operation of the sheet conveyor with a cause of the jam, to generate a learning model.
